(19) United States
(12) Patent Application Publication
(10) Pub. No.: US 2012/0274220 A1
(43) Pub. Date: Nov. 1, 2012

(54) DISPLAY LED UNIT AND METHOD FOR CONTROLLING DISPLAY LEDS

(76) Inventors: Stefan Fehling, Kassel (DE); Alexander Grimm, Wunstorf (DE)

(21) Appl. No.: 13/514,533

(22) PCT Filed: Dec. 8, 2010
(86) PCT No.: PCT/EP2010/069162

§ 371 Date: Jun. 26, 2012

(30) Foreign Application Priority Data
Dec. 8, 2009 (DE) 10 2009 057 124.8

(51) Int. Cl. H05B 37/02

(52) U.S. Cl. 315/152; 315/297

(57) ABSTRACT

There is provided a display LED unit including at least one light emitting diode having a first and a second operating mode. The LED is operated in the forward mode in a first operating mode and a light signal is emitted in dependence on the forward voltage applied to the LED. The LED is operated in the reverse mode with a reverse voltage in a second operating mode and a voltage signal is output in dependence on the ambient light. The display LED unit further comprises a control unit for controlling the light emission of the LED in the first operating mode in dependence on the ambient light detected by the LED in the second operating mode.

The present application claims priority from PCT Patent Application No. PCT/EP2010/069162 filed on Dec. 8, 2010, which claims priority from German Patent Application No. DE 10 2009 057 128.8 filed on Dec. 8, 2009, the disclosures of which are incorporated herein by reference in their entirety.

### BACKGROUND OF THE INVENTION

1. Field of the Invention

The present invention concerns a display LED unit and a method of controlling display LEDs.

2. Description of Related Art

It is noted that citation or identification of any document in this application is not an admission that such document is available as prior art to the present invention.

Light emitting diodes or LEDs have been known for many years and are used in many different products and devices. A possible use of those LEDs is display units, wherein an LED displays for example whether a device is in the standby mode or is switched on.

The noticeability of such LEDs depends on their light intensity and the lighting conditions in the surroundings of the device. Usually light sensors are used to determine the ambient light. The light intensity of the LEDs can be suitably adapted, based on those measurements.

A disadvantage in that respect however is that, in addition to the display LEDs, light sensors (such as for example photodiodes) have to be provided in or on the devices. That possibly requires adaptation in the design of the devices and the costs of such devices also rise.

U.S. Pat. No. 7,508,317 B2 describes a method of controlling the light intensity of power LEDs in a railroad signaling lamp. The control is based on the photoelectric effect which is triggered by those power LEDs when light is incident on the LEDs. For that purpose the light emitting diodes are operated in first time intervals in a first operating mode as light emitting diodes and are operated in second time intervals as photodiodes, that is to say the LEDs are passively operated as photodiodes or as light sensors in a second operating mode. No voltage is applied to the LEDs during that time. The light intensity ascertained in the second operating mode is then used to control the brightness of the LEDs in the first operating mode. That is effected based on a current or voltage control. In that case the time interval for the second operating mode is selected to be substantially less than the time interval for the first operating mode.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of any previously described product, method of making the product, or process of using the product.

### SUMMARY OF THE INVENTION

An object of the present invention is to provide a display LED unit and a method of controlling a display LED which can adapt the intensity of the LEDs to the ambient light intensity in a simple fashion.

Thus there is provided a display LED unit comprising at least one light emitting diode having a first and a second operating mode. The LED is operated in the forward mode in a first operating mode and a light signal is emitted in dependence on the forward voltage applied to the LED. The LED is operated in the reverse mode with a reverse voltage in a second operating mode and a voltage signal is output in dependence on the ambient light. The display LED unit further comprises a control unit for controlling the light emission of the LED in the first operating mode in dependence on the ambient light detected by the LED in the second operating mode.

In an aspect of the invention the control unit is adapted to actuate the LED by a pulse width modulated signal in first and second time intervals. The first operating mode is activated in the first time intervals and the second operating mode is activated in the second time intervals.

In a further aspect of the invention the control unit is adapted to control the length of the first time intervals in dependence on the light intensity, detected in the second operating mode, of the ambient light.

In a further aspect of the invention the control unit is adapted to detect the voltage at the LED in the second operating mode.

The invention also concerns a method of controlling a display LED. An LED is operated in the forward mode in a first operating mode. The LED is operated in the reverse mode in the second operating mode. The voltage at the LED in the second operating mode is detected. The LED is controlled in the first operating mode based on the voltage detected in the second operating mode at the LED.

The invention concerns the idea of using an LED both for producing light (first operating mode) and also for detecting ambient light (second operating mode). In that case the LED is operated in a first operating mode (emission of light) in the forward mode and in a second operating mode as a light sensor in the reverse mode. A voltage is applied to the LED both in the first and also in the second operating mode. The light intensity of the ambient surroundings, detected in the second operating mode, is used to control the LEDs in the first operating mode.

The light intensity of the LEDs in the first operating mode can be controlled or regulated by pulse width modulation PWM. The basic frequency of pulse width modulation can in that case be ≧100 Hz.

### BRIEF DESCRIPTION OF THE DRAWINGS

FIG. 1 shows a circuit in principle of an LED in a reverse mode in a first embodiment; and

FIG. 2 shows a view of a display LED unit in a second embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

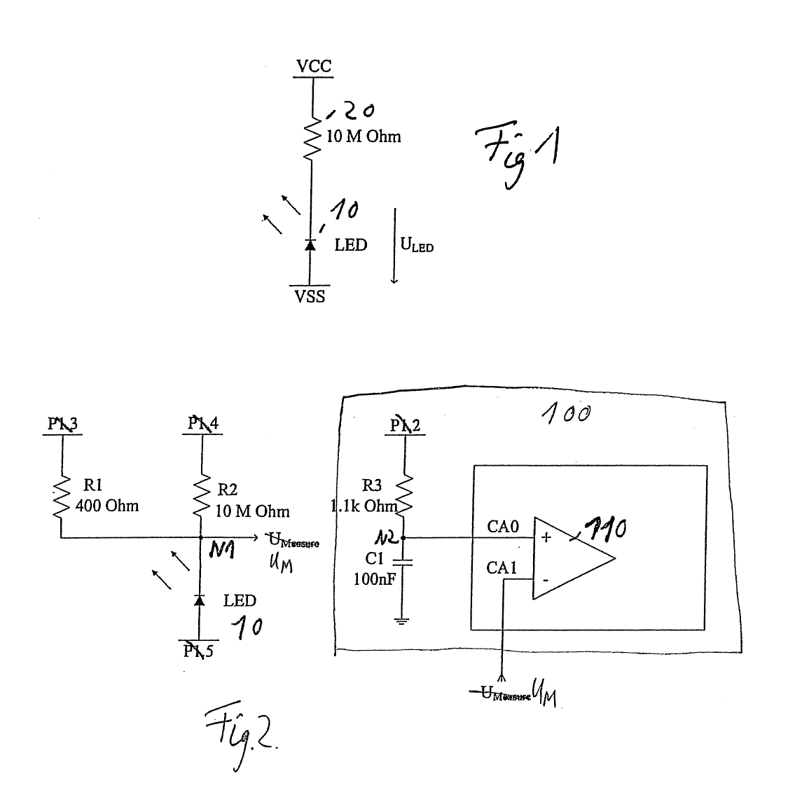

FIG. 1 shows a circuit in principle of an LED in a reverse mode in a first embodiment. FIG. 1 shows a light emitting diode LED 10 and a resistor 20 of 10 M ohms. The LED 10 and the resistor 20 are connected in series between the voltages V_{CC} and V_{SS}. A voltage U_{LED} drops across the LED 10. That voltage U_{LED} drops at the LED 10 if it is operated in the reverse mode as shown in FIG. 1. That voltage U_{LED} changes because of a change in the internal resistance Rᵢ of the LED 10 upon changes in the ambient light. The resistor 20 serves as a high-ohmic resistor to be able to measure the voltage U_{LED} well.

In a second embodiment an LED in a display LED unit is operated in a first operating mode (LED) and in a second operating mode (sensor mode). In the first operating mode the LED is operated in the forward mode with a suitable forward voltage and in a second operating mode the LED is operated in a reverse mode with a suitable reverse voltage. Control of the display LED can be effected by a control unit such as for example a microcontroller.

FIG. 2 shows a view of a display LED unit in the second embodiment. The display LED unit has a control unit 100, a light emitting diode LED 10, a first, second and third resistor R1, R2, R3 and a capacitor C1. The display LED unit has terminals P2-P5. The LED 10 is connected in series with the second resistor R2 between a fourth and fifth terminal P4, P5. A voltage U_{M} is measured at a first node N1 between the LED 10 and the second resistor R2. A first resistor R1 is provided between the node N1 and a third terminal P3. The capacitor C1 is provided between ground and a second node N2. The third resistor R3 is provided between the second node and the second terminal P2. The control unit 100 optionally has an amplifier unit 110 having first and second terminals CA0, CA1. The first terminal CA0 can be coupled to the second node N2 and the second terminal CA1 can be coupled to the first node N1 and thus receives the measurement voltage U_{M}.

The terminals P3, P4, P5 represent input/output terminals. The voltage U_{M} can optionally be measured by a sigma-delta analog/digital converter. That sigma-delta analog/digital converter is formed by the terminal P2 (with the series circuit of the resistor R3 and the capacitor C1) and by the first and second terminals CA0, CA1 of the amplifier 110.

The display LED unit of the second embodiment can be operated in a first operating mode (LED mode) and in a second operating mode (light sensor). In a first operating mode a respective low-level signal is applied to the third terminal P3 and the fourth terminal P4 while a high-level signal is output at the fifth terminal. In the second operating mode the terminal P3 serves as a high-ohmic input and a high-level output signal occurs at the fourth terminal P4 and a low-level output signal occurs at the fifth terminal P5.

In the first operating mode (LED) the LED 10 is actuated by a pulse width modulated PWM signal. The basic frequency of that PWM signal should preferably be ≧100 Hz. If the PWM signal is at a high level then the LED 10 lights. The light intensity of the LED 10 is then determined by the pulse width. In the second operating mode (sensor mode) the LED 10 is operated as a sensor. While the LED 10 is operated in the forward mode in the first operating mode, the LED 10 is operated in the reverse mode in the second operating mode.

If the PWM signal is at a low level then the LED 10 is connected as a light sensor and is operated in the reverse mode. A measurement voltage U_{M} will be present at the node N1 corresponding to the existing ambient light. That measurement voltage U_{M} is measured by the sigma-delta analog/digital converter.

In the LED mode (first operating mode), the resulting resistance of the LED 10 arises out of a parallel connection of the first and second resistors, that is to say a parallel connection of 400 ohms and 10 M ohms, that is to say the resulting resistance is approximately 400 ohms.

It should be pointed out that typically only very low currents (μA) flow so that measurement must be implemented in high-ohmic fashion. That is afforded by the second resistor and by the connection of the third terminal P3 as an input.

Preferably the resolution of the analog/digital converter is low to provide sufficient speed for the analog/digital converter. In addition the process cycle of the microcontroller should be high to provide for rapid conversion in the first operating mode. The resistor R3 and the capacitor C1 can be selected in accordance with the desired resolution. The resolution is selected to be low only for the reason that the sigma-delta analog/digital converter requires a certain conversion time and in general not many brightness steps are required. In other faster voltage measurement methods it is also possible to select a higher level of resolution. The important consideration is how many brightness steps are to be detected in the marked portion.

The PWM signal has first and second time intervals. During the first time interval the display LED unit is operated in the first operating mode and in the second time interval it is operated in a second operating mode. In that respect the second time interval should be adapted at least in such a way that voltage measurement can be effected.

As an alternative to the above-described sigma-delta analog/digital converter it is also possible to provide a microcontroller with integrated analog/digital converter or other voltage measurement methods.

The light intensity of the LEDs can be controlled by the control unit 100 (microcontroller) in the second embodiment in the first operating mode, on the basis of the measured light intensity in the second operating mode.

According to the invention different LED types (with the exception of red and non-transparent LEDs) can be used.

The display LED unit can be used in a mobile apparatus or a mobile electronic device. In that case the mobile electronic device can have a battery in the housing. Power or current can be saved (in dependence on the detected brightness in the ambient surroundings of the device) by means of the display LED unit according to the invention, by controlling the light emission of the light emitting diodes. The mobile apparatus can further have a display which has a display LED unit. In that case the display LED unit can be used for lighting or backlighting the display. Alternatively or in addition thereto the display LED unit can also be used as part of the display, that is to say to represent the corresponding data.

The current measured in the case of the LED according to the invention can be used for controlling the display, in particular to save on current.

The display LED unit can also be used in other electronic apparatuses. In particular the display LED unit serves to control the brightness of a display or the lighting or backlighting of a keyboard. That can be effected in particular in regard to an improvement in energy efficiency.

The display LED unit according to the invention makes it possible to dispense with a separate diode for detecting ambient brightness. The brightness detected by the display LED unit according to the invention can be used for controlling (a part/element of) a mobile electronic device.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A display LED unit comprising:
at least one light emitting diode LED having a first and a second operating mode;
a control unit for controlling the light emission of the LED in a first operating mode in dependence on ambient light detected by the LED in a second operating mode; and
at least a first resistor having a first terminal in series in relation to the least one light emitting diode with a second terminal;
wherein the LED is operated in a forward mode in the first operating mode, and emits a light signal in dependence on a forward voltage applied to the LED;
wherein the LED is operated in a reverse mode with a reverse voltage in the second operating mode, and outputs a voltage signal in dependence on the ambient light detected by the LED; and
wherein, in the first operating mode, a low-level signal occurs at the first terminal and a high-level signal occurs at the second terminal; and
wherein, in the second operating mode, a high-level signal occurs at the first terminal and a low-level signal occurs at the second terminal.

2. The display LED unit as set forth in claim 1;
wherein the control unit is configured to actuate the LED by a pulse width modulated signal having first time intervals and second time intervals; and
wherein the first operating mode is activated in the first time intervals, and the second operating mode is activated in the second time intervals.

3. The display LED unit as set forth in claim 1;
wherein the control unit is configured to control a length of the first time intervals in dependence on a light intensity, detected in the second operating mode, of the ambient light detected by the LED.

4. The display LED unit as set forth in claim 1;
wherein the control unit is configured to detect a voltage at the LED in the second operating mode.

5. A method of controlling a display LED, which includes at least one light emitting diode LED, and at least a first resistor having a first terminal in series in relation to the at least one light emitting diode with a second terminal, the method comprising:
operating an LED in a forward mode in a first operating mode;
applying a low-level signal to the first terminal and a high-level signal to the second terminal;
operating the LED in a reverse mode in a second operating mode;
applying a high-level signal to the first terminal and a low-level signal to the second terminal;
detecting voltage at the LED in the second operating mode; and
controlling the LED in the first operating mode based on the voltage detected at the LED in the second operating mode.

6. A portable mobile electronic device comprising:
a housing;
a power supply in the housing;
a display and/or a display lighting means or backlighting means; and
a display LED unit which includes:
at least one light emitting diode having a first and a second operating mode;
a control unit for controlling light emission of the at least one light emitting diode in a first operating mode in dependence on ambient light detected by the at least one light emitting diode in a second operating mode;
at least a first resistor having a first terminal in series in relation to the least one light emitting diode with a second terminal;
wherein the at least one light emitting diode is operated in a forward mode in the first operating mode, and emits a light signal in dependence on a forward voltage applied to the light emitting diode;
wherein the light emitting diode is operated in a reverse mode with a reverse voltage in the second operating mode, and outputs a voltage signal in dependence on the ambient light detected by the at least one light emitting diode; and
wherein, in the first operating mode, a low-level signal occurs at the first terminal and a high-level signal occurs at the second terminal;
wherein, in the second operating mode, a high-level signal occurs at the first terminal and a low-level signal occurs at the second terminal.

7. An electronic device comprising:
a display, and/or a lighting means or backlighting means for the display; and
a display LED unit as set forth in claim 1;
wherein a brightness of the display, and/or the lighting means or backlighting means, is controlled by the control unit of the display LED unit.

8. An electronic device comprising:
a display, and/or a lighting means or backlighting means for the display; and
a display LED unit as set forth in claim 2;
wherein a brightness of the display, and/or the lighting means or backlighting means, is controlled by the control unit of the display LED unit.

9. An electronic device comprising:
a display, and/or a lighting means or backlighting means for the display; and
a display LED unit as set forth in claim 3;
wherein a brightness of the display, and/or the lighting means or backlighting means, is controlled by the control unit of the display LED unit.

10. An electronic device comprising:
a display, and/or a lighting means or backlighting means for the display; and
a display LED unit as set forth in claim 4;
wherein a brightness of the display, and/or the lighting means or backlighting means, is controlled by the control unit of the display LED unit.
